(19) United States
(12) Patent Application Publication
(10) Pub. No.: US 2023/0334198 A1
(43) Pub. Date: Oct. 19, 2023

(54) STRUCTURAL DYNAMIC PARAMETER IDENTIFICATION METHOD AIDED BY rPCK SURROGATE MODEL

(71) Applicants: Jiangxi University of Science and Technology, Ganzhou (CN); Hohai University, Nanjing (CN); China Three Gorges Construction (Group) Co., Ltd., Beijing (CN); JSTI Group, Nanjing (CN)

(72) Inventors: Maosen CAO, Nanjing (CN); Yazhou JIANG, Beijing (CN); Tongfa DENG, Ganzhou (CN); Yifei LI, Nanjing (CN); Yufeng ZHANG, Nanjing (CN); Lei SHEN, Nanjing (CN); Li CUI, Nanjing (CN); Zeyu WANG, Nanjing (CN); Jiayi PENG, Nanjing (CN)

(73) Assignees: Jiangxi University of Science and Technology, Ganzhou (CN); Hohai University, Nanjing (CN); China Three Gorges Construction (Group) Co., Ltd., Beijing (CN); JSTI Group, Nanjing (CN)

(21) Appl. No.: 18/135,218

(22) Filed: Apr. 17, 2023

(30) Foreign Application Priority Data
Apr. 18, 2022 (CN) 202210402995.9

(51) Int. Cl. G06F 30/23; G06F 30/13; G06F 17/13

(52) U.S. Cl. CPC G06F 30/23; G06F 30/13; G06F 17/13

(57) ABSTRACT

A structural dynamic parameter identification method aided by a rPCK surrogate model comprises the following steps. Establish a finite element model that roughly reflects the structural system to be analyzed. Establish the dynamic parameter space sample set. The structural system response space sample set driven by the dynamic parameter space sample set is established by using the probabilistic finite element analysis. The robust polynomial Chaos Kriging surrogate model is obtained by mapping the dynamic parameter space sample set to the structural system response space sample set. The measured structural system response is used to drive the rPCK surrogate model, and then Bayesian inference is used to identify the structural dynamic parameters. The mean value of Bayesian posterior estimation is used as the estimated value of structural dynamic parameters. The proposed method creates conditions for establishing a high-fidelity finite element model of the actual engineering structural system.

### CROSS-REFERENCE TO THE RELATED APPLICATION

This application is based upon and claims priority to Chinese Patent Application No. 202210402995.9, filed on Apr. 18, 2022, the entire content of whiCh is incorporated herein by reference.

### TECHNICAL FIELD

The invention belongs to the field of structural engineering, in particular to a structural dynamic parameter identification method aided by rPCK surrogate model.

### BACKGROUND

The water conservancy and hydropower industry have flourished for decades in China, and the number of dams has exceeded 40% of the world's total number. Many dams built in the early stage are gradually aging, and the newly built super high arch dams in the past decade are mostly built on the strong seismic zone of high mountains and narrow valleys in the southwest region due to their unique functions, the seismic safety is one of the main problems to be solved in dam design. At present, the finite element method is usually used in the seismic safety analysis of dams, and the dynamic parameters of dam materials are the main factors affecting the results of finite element analysis. in engineering, the dynamic parameters of darn materials are usually determined. by an indoor test method. However, due to the influence of construction technology, method, environment, and quality on the density and elastic modulus of dam materials at the dam construction site, there are usually some differences compared with the parameter values determined by the laboratory test method, and these dynamic parameters directly affect the overall dynamic characteristics of the dam. Therefore, the physical parameters determined by the darn concrete and bedrock materials during construction and operation based on the inverse analytical method is very important for dam safety analysis.

The existing darn parameter identification methods are mostly based on the deterministic inverse analysis of static monitoring data such as multi-point displacement. This method not only ignores the inherent random characteristics of the material but also the multi-point displacement can only reflect the local static characteristics of the dam. It is difficult to characterize the temporal full-field mechanical properties of the dam structure as a whole. In addition, the established finite element model which can roughly reflect the behavior of the structural system to be analyzed is usually extremely expensive, especially for high-order modal analysis and transient analysis, the existing darn parameter identification methods are stretched.

### SUMMARY

In order to overcome the shortcomings of the above existing technologies, the invention provides a structural dynamic parameter identification method aided by rPCK surrogate model.

To achieve the above purpose, the invention provides the following technical solution:

The structural dynamic parameter identification method aided by rPCK surrogate model includes the following steps:

The finite element model that roughly reflects the structural system to be analyzed is obtained by scaling the structural system to a set proportion.

The probability distribution function of the dynamic parameters in the finite element model is determined by prior knowledge, and the Latin hypercube sampling method is used to generate the dynamic parameter space sample set according to the probability distribution function. Among them, the dynamic parameters include: the dynamic elastic modulus, the density, and the Poisson ratio of the dam; the dynamic elastic modulus, the density, and the Poisson ratio of the dam foundation.

The dynamic parameter space sample set is analyzed by the probabilistic finite element method, and the response space sample set of the structural system driven by the dynamic parameter space sample set is established.

The robust polynomial Chaos Kriging surrogate model is obtained by mapping the dynamic parameter space sample set to the structural system response space sample set.

The measured response of the structural system to be analyzed is used to drive the robust polynomial Chaos Kriging surrogate model. The Bayesian inference is used to identify the structural dynamic parameters of the structural system to be analyzed. The Bayesian posterior estimation mean value is used as the structural dynamic parameter estimates of the dynamic elastic modulus and the darn density of the darn and the darn foundation.

Preferably, the robust polynomial Chaos Kriging surrogate model M^{PCK}(x) is obtained by using the following formula:

$$Y \approx {M}^{PCK} ( x ) = {\sum }_{α ∈ {N}^{M}} {β}_{α} {Ψ}_{α} ( X ) + {σ}^{2} Z ( x )$$

Where Y is the structural system response predicted by the surrogate model, M is the number of unknown structural dynamic parameter variables, N^{M} is the set of M dimension natural number vectors, β_{α} is the undetermined polynomial expansion coefficient, α is the subscript of the M dimension basis function index, X={X₁, X₂, . . . , X_{M}} is the M dimension dynamic parameter space sample with independent components, x ∈ D_{X} ⊂ [symbol] ^{M} is the Gaussian process index, σ² is the variance of the Gaussian process, and Z(x) is the Gaussian process with zero mean value and covariance functions;

In the formula, ψ_{α}(X) is the joint probability density function orthogonal multivariate basis function relates to X.

$${ψ}_{α} ( X ) = {\prod }_{i = 1}^{M} {ϕ}_{{α}_{i}}^{( i )} ( {x}_{i} )$$

In the formula, αᵢ is the polynomial degree, ϕ_{α}_{ᵢ}⁽ⁱ⁾ is the univariate orthogonal polynomial in the i-th variable according to αᵢ, and xᵢ is the i-th univariate in the dynamic parameter space sample set.

Preferably, the steps to obtain the robust polynomial Chaos Kriging surrogate model M^{PCK} (x) also include:

The least angle regression method is used to calculate the undetermined expansion coefficient β_{α} in the robust polynomial Chaos Kriging surrogate model M^{PCK} (x)

Calibrate the Z(x) in the robust polynomial Chaos Kriging surrogate model M^{PCK} (x).

Preferably, the undetermined expansion coefficient β_{α} in the robust polynomial Chaos Kriging surrogate model is calculated by the least angle regression method. according to the following formula:

$$\hat{β} = arg {min}_{β ∈ {ℝ}^{P}} E [ {( {β}^{T} ψ ( X ) - Y )}^{2} ] + λ {‖ β ‖}_{1}$$

Where β is the polynomial expansion coefficient vector, \hat{β} is the polynomial coefficient that minimizes the mathematical expectation, [symbol] ^{P} is the truncated natural number vector set, where P=A^{M,p} is the truncation error, A ∈ N^{M} is the multi-index truncated set of the polynomial cardinality, p is the polynomial order, λ is the penalty factor of the penalty term, ∥β∥₁ is the norm of the polynomial expansion coefficient vector.

∥\hat{β} ∥₁ is a regularization term that is forced to minimize to support low-rank solutions.

∥\hat{β} ∥₁=Σ_{α∈A} |β|

Preferably, the steps for calibrating Z(x) in the robust polynomial Chaos Kriging surrogate model M^{PCL} (x) include:

Defined Z(x) as follows:

Z(x)=Cov (z(xᵢ), Z(xⱼ))=σ²R (xᵢ, xⱼ; θ)

Where, Z(xᵢ) is the observed value, Z(xⱼ) is the new interpolation, R(xᵢ, xⱼ; θ)is the function describing the similarity between the observed value Z(xᵢ) and the new interpolation ZOO by the hyperparameter θ=[θ₁, . . . , θₙ]^{T}, xᵢ and xⱼ are a pair of sampling points in the response space of the structural system.

Using the maximum likelihood estimation to estimate hyperparameter θ according to the following formula:

$$\hat{θ} = arg {min}_{θ ∈ {D}_{θ}} \frac{1}{2} [ log ( det R ) + M log ( 2 π {σ}^{2} ) + M ]$$

In the formula, D_{θ} is the parameter space of θ, R is the abbreviation of R(xᵢ, xⱼ; θ).

The steps of using Bayesian inference to identify the structural dynamic parameters of the structural system to be analyzed include:

When the unknown structural dynamic parameter variables X={x₁, . . . , x_{M}} cannot be measured directly, establish N independent measurements yi and collect Y [symbol] {y₁, . . . , y_{N}} in the data set Y.

A discrepancy term is introduced to link the predicted value X={xᵢ, . . . , x_{M}} of the model with the observed result Y [symbol] {y₁, . . . , y_{N}} to obtain the calculation model M:

M:x ∈ Dₓ ⊂ [symbol] ^{M} [symbol] y=M (x)+ϵ ∈ [symbol] ^{N}^{ₒᵤₜ}

In this formula, ϵ ∈ [symbol] ^{N}^{ₒᵤₜ} is the discrepancy term describing the difference between experimental observations and model predictions, and ϵ˜N(ϵ|0, σ²);

The model parameter x_{M} and the discrepancy parameter x_{ϵ} in the structural dynamic parameter vector x are calculated according to the observation result Y [symbol] {y₁, . . . , y_{N}}. The model parameter x_{M} is used to characterize the model prediction value X={x₁, . . . , x_{M}}.

Preferably, the steps for calculating model parameter x_{M} and the discrepancy parameter x_{ϵ} in the structural dynamic parameter vector x are calculated according to the observation result Y [symbol] {y₁, . . . , y_{N}} including:

The joint prior distribution of the model parameter x_{M} and the discrepancy parameter x_{ϵ} is obtained as follows:

π(x)=π(x_{M})π(σ²)

According to the observation result Y [symbol] {y₁, . . . , y_{N}}, the likelihood function of the model parameter x_{M} is obtained as follows.

$$L ( {x}_{M} , {σ}^{2} ; Y ) = {\prod }_{i = 1}^{N} \frac{1}{\sqrt{{( 2 π {σ}^{2} )}^{{N}_{out}}}} exp ( \frac{1}{2 {σ}^{2}} {( {y}_{i} - M ( {x}_{M} ) )}^{T} ( {y}_{i} - M ( {x}_{M} ) ) )$$

Where N is the number of measured response parameters of the structural system to be analyzed, Nₒᵤₜ is the number of response parameters of the structural system to be analyzed predicted by the surrogate model.

According to the joint prior distribution of the model parameter x_{M} and the discrepancy parameter x_{ϵ} and the likelihood function of the model parameter x_{M}, the posterior distribution of the model parameter x_{M} is obtained as follows:

$$π ( {x}_{M} , {σ}^{2} \vert Y ) = \frac{1}{Z} π ( {x}_{M} ) π ( {σ}^{2} ) L ( {x}_{M} , {σ}^{2} ; Y )$$

In the formula, Z is a normalization factor with a distribution integral of 1.

$$Z {=}^{def} {\int }_{Dx} L ( {x}_{M} , {σ}^{2} ; Y ) π ( x ) dx$$

In the formula, Dx is the parameter space of x;

The first statistical moment is used to represent the predicted value X={x₁, . . . , x_{M}} of the model according to the posterior distribution based on the model parameter x_{M}.

E[X|Y]=∫_{Dx} xπ(x|Y)dx

Preferably, the uncertainty of point estimation is quantified by the posterior covariance matrix according to the following formula.

Cov[X|Y]=∫_{Dx} (x−E[X|Y])(x−E[X|Y])^{T} π(x|Y) dx

Preferably, it also includes:

The sample spectrum of the structural system to be analyzed is constructed by using the dynamic parameter space sample set and the structural system response space sample set.

The prediction model is generated based on the sample spectrum of the structural system until the accuracy of the prediction model meets the requirements. The prediction model is used as a robust polynomial Chaos Kriging surrogate model. Otherwise, the dynamic parameter space sample set and the system response space sample set are repeatedly generated, and the prediction model is established by using the new dynamic parameter space sample set and the system response space sample set until the accuracy of the prediction model meets the requirements.

Preferably, it also includes:

The high-fidelity finite element model of the structural system is established by using structural dynamic parameter estimates.

The system response of the high-fidelity model is compared with the measured structural system response.

The structural dynamic parameter identification method aided by rPCK surrogate model provided by the invention has the following beneficial effects: The invention significantly reduces the number of calls to the finite element model of the structural system and breaks through the limitations of the existing parameter identification methods which make it difficult to accurately determine the dynamic parameters of the structure, and it is of good practicality. The polynomial Chaos Kriging surrogate model established by the invention makes up for the deficiency of neglecting the random distribution of materials in traditional dynamic parameter identification by introducing the probability prior model in statistics. The invention transcends the limitations of most existing surrogate models used for static parameter identification of structural systems and creates conditions for establishing a high-fidelity finite element model of an actual engineering structural system.

The following is a further explanation of the invention in combination with drawings and embodiment.

### BRIEF DESCRIPTION OF THE DRAWINGS

In order to explain the embodiment of the invention and its design scheme more clearly, the attached drawings required by the embodiment are briefly introduced below The drawings in the following description are only part of the embodiments of the invention. For ordinary technicians in this field, other drawings can he obtained. according to these drawings without paying creative labor.

FIG. 1 is the flow chart of the structural dynamic parameter identification method. aided by rPCK surrogate model in embodiment 1;

FIG. 2 is the fine finite element model of an arch dam prototype in embodiment 1;

FIG. 3 is the simplified small-scaled finite element model of an arch dam based on a 1:200 scale in embodiment 1;

FIG. 4 is the hammering test frequency response function diagram of a small-scaled arch dam model in embodiment 1 of the invention:

FIG. 5 is the accuracy evaluation diagram of the rPCK model in embodiment 1;

FIG. 6 is the calculated natural frequency curves and measured natural frequency distributions before and after identification of the structural dynamic parameters aided by rPCK surrogate model in embodiment 1.

### DETAILED DESCRIPTION OF THE EMBODIMENTS

In order to make the technical personnel in this field a better understanding of the technical solution of this invention and then carry out the implementation, a detailed description of the invention in combination with the attached drawings and embodiments are provided in the following. The following embodiment is only used to clarify the technical solution more clearly and cannot be used to limit the protection scope of the invention.

### Embodiment 1

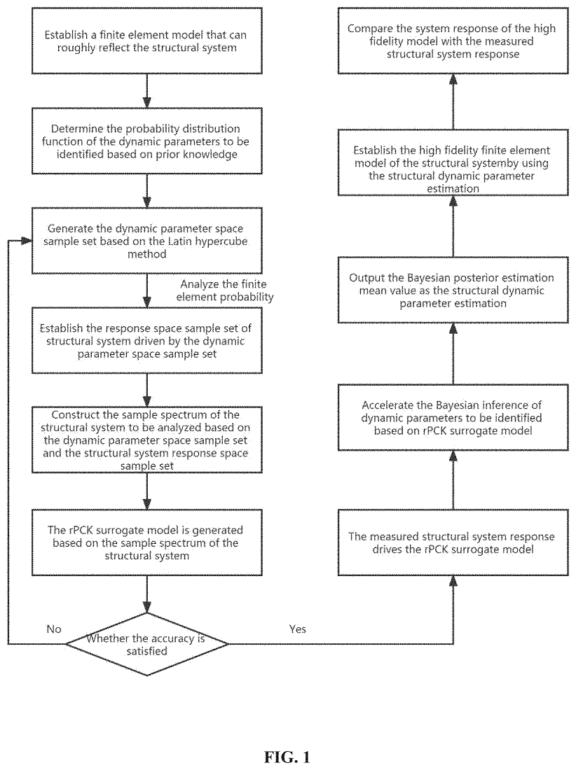

Referring to FIG. 1, this invention provides a structural dynamic parameter identification method aided by rPCK surrogate model which includes the following steps: The finite element model that roughly reflects the structural system to be analyzed is obtained by scaling the structural system to a set proportion. The probability distribution function of the dynamic parameters in the finite element model is determined by prior knowledge, and the Latin hypercube sampling method is used to generate the dynamic parameter space sample set according to the probability distribution function. Among them, the dynamic parameters include: the dynamic elastic modulus, the density, and the Poisson ratio of the dam; the dynamic elastic modulus, the density, and the Poisson ratio of the dam foundation; The dynamic parameter space sample set is analyzed by probabilistic finite element method, and the response space sample set of structural system driven by dynamic parameter space sample set is established. The robust polynomial Chaos Kriging surrogate model is obtained by mapping the dynamic parameter space sample set to the structural system response space sample set. The measured response of the structural system to be analyzed is used to drive the robust polynomial Chaos Kriging surrogate model. The Bayesian inference is used to identify the structural dynamic parameters of the structural system to be analyzed. The mean of Bayesian posterior estimation is used as the structural dynamic parameter estimates.

The steps of establishing the robust polynomial Chaos Kriging surrogate model M^{PCK} (x) include: Using the dynamic parameter space sample set and structural system response space sample set to construct the sample spectrum of the structural system to be analyzed; the prediction model is generated based on the sample spectrum of the structural system until the accuracy of the prediction model meets the requirements. The prediction model is used as a robust polynomial Chaos Kriging surrogate model. Otherwise, the dynamic parameter space sample set and the system response space sample set are repeatedly generated, and the prediction model is established by using the new dynamic parameter space sample set and the system response space sample set until the accuracy of the prediction model meets the requirements.

In this embodiment, the robust polynomial Chaos Kriging surrogate model M^{PCK} (x) is obtained by using the following formula:

$$Y \approx {M}^{PCK} ( x ) = {\sum }_{α ∈ {N}^{M}} {β}_{α} {Ψ}_{α} ( X ) + {σ}^{2} Z ( x )$$

Where Y is the structural system response predicted by the surrogate model, M is the number of unknown structural dynamic parameter variables, N^{M} is the set of M dimension natural number vectors, β_{α}is the undetermined polynomial expansion coefficient, a is the subscript of the M dimension basis function index, X={X₁, X₂, . . . , X_{M}} is the M dimension dynamic parameter space sample with independent components, x ∈ Dₓ ∈ [symbol] ^{M} is the Gaussian process index, σ² is the variance of the Gaussian process, and Z(x) is the Gaussian process with zero mean value and covariance functions;

In the formula, ψ_{α}(X) is the joint probability density function orthogonal multivariate basis function relates to X.

$${ψ}_{α} ( X ) = {\prod }_{i = 1}^{M} {ϕ}_{{α}_{i}}^{( i )} ( {x}_{i} )$$

In the formula, ai is the polynomial degree, ϕ_{α}_{ᵢ}⁽ⁱ⁾ is the univariate orthogonal polynomial in the i-th variable according to αᵢ , and xᵢ is the i-th univariate in the dynamic parameter space sample set.

After the robust polynomial Chaos Kriging surrogate model M^{PCL} (x) is obtained, the least angle regression method is used to calculate the undetermined expansion coefficient β_{α} in the robust polynomial Chaos Kriging surrogate model M^{PCL} (x). Calibrate the Z(x) in the robust polynomial Chaos Kriging surrogate model. M^{PCL} (x).

Specifically, the undetermined expansion coefficient β_{α} in the robust polynomial Chaos Kriging surrogate model is calculated by the least angle regression method according to the following formula:

$$\hat{β} = arg {min}_{β ∈ {ℝ}^{P}} E [ {( {β}^{T} ψ ( X ) - Y )}^{2} ] + λ {‖ β ‖}_{1}$$

Where β is the polynomial expansion coefficient vector, \hat{β} is the polynomial coefficient that minimizes the mathematical expectation, [symbol] ^{P} is the truncated natural number vector set, where P=A^{M,p} is the truncation error, A ∈ N^{M} is the multi-index truncated set of the polynomial cardinality, p is the polynomial order, λ is the penalty factor of the penalty term, ∥β∥₁ is the norm of the polynomial expansion coefficient vector.

∥\hat{β} ∥₁ is a regularization term that is forced to minimize to support tow-rank solutions.

∥\hat{β} ∥₁=Σ_{α∈A} |β_{α}|

Preferably, the steps for calibrating Z(x) in the robust polynomial Chaos Kriging surrogate model M^{PCK} (x) include:

Defined Z(x) as follows:

Z(x)=Cov (Z(xᵢ), Z(xⱼ))=σ²R(xᵢ, xⱼ; θ)

Where, Z(xᵢ) is the observed value, Z(xⱼ) is the new interpolation, R(xᵢ, xⱼ; θ) is the function describing the similarity between the observed value Z(xᵢ) and the new interpolation Z(xⱼ) by the hyperparameter θ=[θ₁, . . . , θₙ]^{T}, xᵢ and xⱼ are a pair of sampling points in the response space of the structural system.

Using the maximum likelihood estimation to estimate hyperparameter θ according to the following formula:

$$\hat{θ} = arg {min}_{θ ∈ {D}_{θ}} \frac{1}{2} [ log ( det R ) + M log ( 2 π {σ}^{2} ) + M ]$$

In the formula, D_{θ} is the parameter space of θ, R is the abbreviation of R(xᵢ, xⱼ; θ).

Specifically, the steps of using Bayesian inference to identif the structural dynamic parameters of the structural system to be analyzed include: When the unknown structural dynamic parameter variables X={x₁, . . . , x_{M}} cannot be measured directly, it can be resorted to the engineering measurement or the experimental measurement of structural system response only, establish N independent measurements yi and collect Y [symbol] {y₁, . . . , y_{N}}0 in the data set Y based on those measurements. A discrepancy term is introduced to link the predicted value X={x₁, . . . , x_{M}} of the model with the observed result Y [symbol] {y₁, . . . , y_{N}} to obtain the calculation model M:

M:x ∈ Dₓ ⊂ [symbol] ^{M} [symbol] y=M (x)+ϵ ∈ [symbol] ^{N}^{ₒᵤₜ}

In this formula, ϵ ∈ [symbol] ^{N}^{ₒᵤₜ} is the discrepancy term describing the difference between experimental observations and model predictions, and ϵ˜N(ϵ|0, σ²); The model parameter x_{M} and the discrepancy parameter x_{ϵ} in the structural dynamic parameter vector x are calculated according to the observation result Y [symbol] {y₁, . . . ,y_{N}}. The model parameter x_{M} is used to characterize the model prediction value X={x₁, . . . , x_{M}}.

It is assumed that the model parameter x_{M} and the discrepancy parameter x_{ϵ} are independent of each other in the priority class, and the prior distribution π(xₛ) of the unknown variance σ² can be obtained. The steps of calculating the model parameter x_{M} and the discrepancy parameter x_{ϵ} in the structural dynamic parameter vector x according to the observation result Y [symbol] {y₁, . . . , y_{N}} include: The joint prior distribution of the model parameter x_{M} and the discrepancy parameter x_{ϵ} is obtained as follows.

π(x)=π(x_{M})π(σ²)

According to the observation result Y [symbol] {y₁, . . . , y_{N}}, the likelihood function of the model parameter x_{M} is obtained as follows.

$$L ( {x}_{M} , {σ}^{2} ; Y ) = {\prod }_{i = 1}^{N} \frac{1}{\sqrt{{( 2 π {σ}^{2} )}^{{N}_{out}}}} exp ( - \frac{1}{2 {σ}^{2}} {( {y}_{i} - M ( {x}_{M} ) )}^{T} ( {y}_{i} - M ( {x}_{M} ) ) )$$

Where N is the number of measured response parameters of the structural system to be analyzed, Nₒᵤₜ is the number of response parameters of the structural system to he analyzed predicted by the surrogate model; According to the joint prior distribution of the model parameter x_{M} and the discrepancy parameter x_{ϵ} and the likelihood function of the model parameter x_{M}, the posterior distribution of the model parameter x_{M} is obtained as follows:

$$π ( {x}_{M} , {σ}^{2} \vert Y ) = \frac{1}{Z} π ( {x}_{M} ) π ( {σ}^{2} ) L ( {x}_{M} , {σ}^{2} ; Y )$$

In the formula, Z is a normalization factor with a distribution integral of 1,

$$Z {=}^{def} {\int }_{Dx} L ( {x}_{M} , {σ}^{2} ; Y ) π ( x ) dx$$

In the formula, Dx is the parameter space of x; The first statistical moment is used to represent the predicted value X={x₁, . . . , x_{M}} of the model according to the posterior distribution based on the model parameter x_{M}.

E[X|Y]=∫_{Dx} xπ)x|Y) dx

Specifically, the uncertainty of point estimation is quantified by the posterior covariance matrix according to the following formula.

Cov [X|Y]=∫_{Dx} (x−E[X|Y])(x−E[X|Y])^{T}π(x|Y) dx

The invention is described below with specific examples.

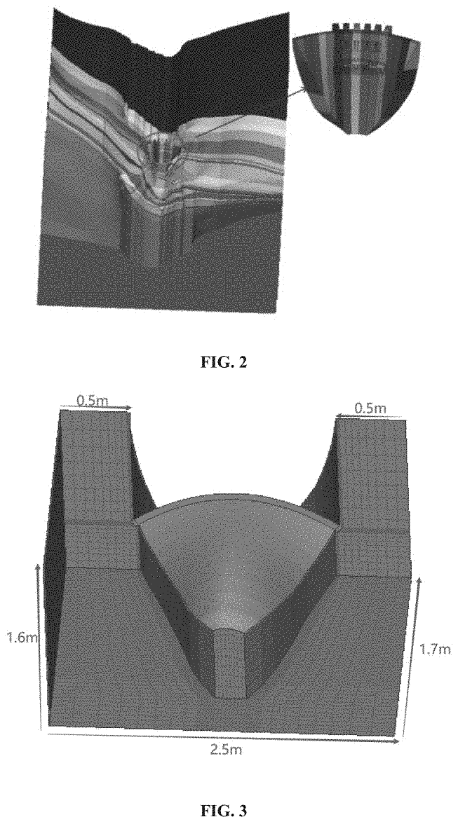

This example studies the dynamic parameter identification of the actual simplified small-scaled arch dam model. In this example, the rPCK surrogate model is used as the abbreviation of the robust polynomial Chaos Kriging surrogate model. The small-scaled arch dam is 1.35 in in height, the prototype dam is 270 m in height, and the scale is 1:200. FIG. 2 and FIG. 3 show the fine finite element model of an arch darn prototype and its simplified small-scaled finite element model.

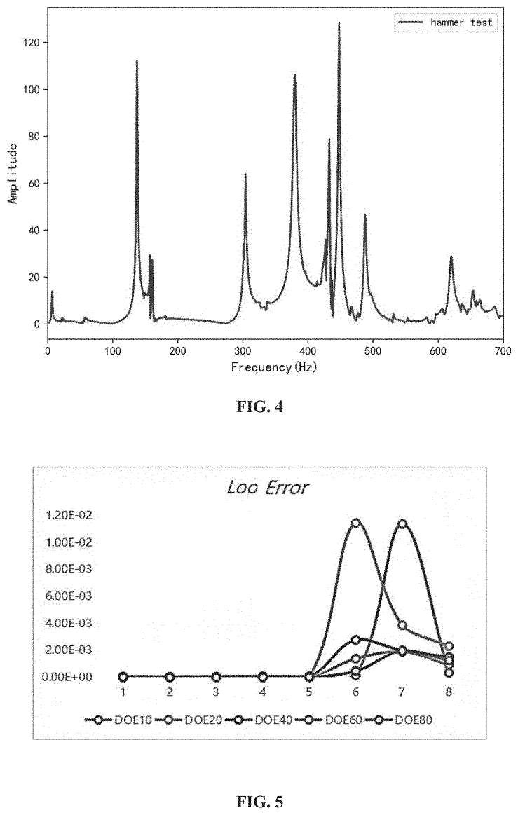

A small-scaled arch dam is established based on the above description, which composes the dam body and the dam foundation. Among them, the dam foundation is completely poured with commercial C30 concrete, and the dam material is prepared according to the principle of scale test and sampled for the dynamic elastic modulus test. After the maintenance is completed, the dynamic response test on this test model based on hammering tests, and the frequency response function is shown in FIG. 4. In addition, Table 1 provides the prior distribution and statistical values of the materials in each zone of the small-scaled arch dam. Taking the empirical pseudo-true value as the mean value of the distribution function and giving it a 10% deviation. The modulus of elasticity and density, which have a large influence on the structural natural frequency, are selected for identification.

TABLE 1
The prior distribution and statistical value of materials
in each zone of the small-scaled arch dam

| | | | Probability | | |
|---|---|---|---|---|---|
| | Sym- | | distribution | | |
| Parameter | bol | Unit | model | Quantity | |
| Dam modulus of | E_{c} | GPa | Gaussian | N | (1.5, 0.15) |
| elasticity | | | | | |
| Dam density | ρ_{c} | Kg/m3 | Gaussian | N | (2200, 220) |
| Dam Poisson ratio | ν_{c} | — | — | 0.22 | |
| Foundation modulus | E_{f} | GPa | Gaussian | N | (30, 3) |
| of elasticity | | | | | |
| Foundation mass | ρ_{f} | Kg/m3 | Gaussian | N | (2400, 240) |
| density | | | | | |
| Foundation Poisson's | ν_{f} | — | — | 0.19 | |
| ratio | | | | | |

Because of the four unknown structural dynamic parameters (the elastic modulus and the density of two material zones) in table 1. The Latin hypercube sampling method was used to generate 100 sets of dynamic parameter space sample sets, and probabilistic finite element analysis (modal analysis) was used to extract the first eight orders of calculated natural frequencies corresponding to the measured natural frequencies as the sample sets of structural system responses characterizing the dam structure dynamic properties. The 100 dynamic parameter space sample sets and corresponding structural system response space sample sets are obtained to construct the sample spectrum of the structural system to be analyzed. The first 80 sets of structural system sample spectra are divided into 5 batches to construct different numbers of design of experiment (DOE), which are 10,20,40,60,80, respectively. The last 20 groups are used as verification data sets to explore the influence of different sample sizes on the accuracy of the rPCK surrogate model.

The accuracy of rPCK model is evaluated by leave-one-out cross-validation error (Err_{LOO}). The formula is as follows:

$${Err}_{LOO} = \frac{{\sum }_{i = 1}^{N} {( M ( {x}^{i} ) - {M}^{metal \backslash i} ( {x}^{i} ) )}^{2}}{{\sum }_{i = 1}^{N} {( M ( {x}^{i} ) - {\hat{μ}}_{Y} )}^{2}}$$

In the formula:

$${\hat{μ}}_{Y} = \frac{1}{N} {\sum }_{i = 1}^{N} M ( {x}^{i} )$$

is the sample average of the experimental design response, M^{metal\i} (·) is the rPCK surrogate model after removing the i th sample point from the complete experimental design.

The root mean square error (RMSE) and the mean absolute percentage error (MAPE) are used to evaluate the accuracy of the structural dynamic parameter identification method aided by rPCK surrogate model. The formula is as follows:

$$RSME = \sqrt{\frac{1}{N} {\sum }_{K = 1}^{N} {( {y}_{K} - \overline{{y}_{K}} )}^{2}} \\ MAPE = \frac{100}{N} {\sum }_{K = 1}^{N} \frac{\vert {y}_{K} - \overline{{y}_{K}} \vert}{{y}_{K}}$$

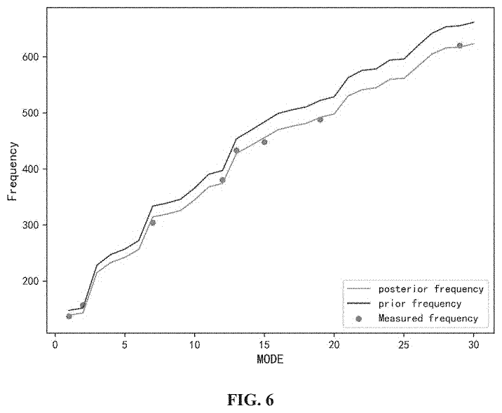

The accuracy evaluation of the constructed rPCK surrogate model is shown in Table 2 and FIG. 5.

TABLE 2
The accuracy evaluation of the rPCK model based on Err_{LOO}

| Frequency | | | | | |
|---|---|---|---|---|---|
| Order | DOE = 10 | DOE = 20 | DOE = 40 | DOE = 60 | DOE = 80 |
| 1 | 6.62E−05 | 7.69E−06 | 3.35E−06 | 7.42E−07 | 7.06E−07 |
| 2 | 4.75E−05 | 9.84E−06 | 1.45E−06 | 7.56E−07 | 4.15E−07 |
| 3 | 5.74E−05 | 7.81E−06 | 1.04E−06 | 4.24E−07 | 2.13E−07 |
| 4 | 8.09E−05 | 1.66E−05 | 1.46E−05 | 8.37E−06 | 5.08E−07 |
| 5 | 6.11E−05 | 1.13E−05 | 6.10E−05 | 1.17E−05 | 7.94E−06 |
| 6 | 1.34E−04 | 1.14E−02 | 2.77E−03 | 1.38E−03 | 4.63E−04 |
| 7 | 1.14E−02 | 3.85E−03 | 1.99E−03 | 1.89E−03 | 1.95E−03 |
| 8 | 3.35E−04 | 2.29E−03 | 1.49E−03 | 9.33E−04 | 1.25E−03 |

It can be seen from Table 2 and FIG. 5 that even for the high-order natural frequency with large errors, the error of the corresponding rPCK surrogate model is still small enough (the maximum is about 1.14%), and the error of the rPCK surrogate model corresponding to the first three natural frequencies that play a dominant role is close to 0, indicating that the constructed PCK surrogate model can replace the original finite element model for the subsequent dynamic parameter identification in an efficient and accurate way. In order to reduce the computational cost further, a set of rPCK. surrogate models with the smallest sample size of the experimental design was chosen for subsequent dynamic parameter identification.

As shown in FIG. 4, the measured natural frequency of the small-scaled arch dam is extracted, which is used to drive the rPCK surrogate model, and then Bayesian inference is used to identify the structural dynamic parameters. The mean value of Bayesian posterior estimation is used as the estimated value of structural dynamic parameters. The results are shown in Table 3.

TABLE 3
The result of probabilistic structural dynamic parameter
identification aided by the rPCK model.

| | | The structural dynamic parameter |
|---|---|---|
| Parameter | Unit | estimation based on rPCK |
| E_{c} | GPa | 1.36 |
| ρ_{c} | Kg/m3 | 2239.07 |
| E_{f} | GPa | 26.87 |
| ρ_{f} | Kg/m3 | 2438.14 |

The high-fidelity finite element model of the structural system is established by using the estimated value of structural dynamic parameters as the structural system parameters. The calculated natural frequency is extracted by finite element analysis and compared with the measured natural frequency. Two common error verification indexes are used to evaluate the accuracy of the method in multiple dimensions. The results are shown in Table 4.

TABLE 4
Comparison between the measured natural frequency
and the finite element calculated value after
the dynamic parameter identification.

| Order of natural | Measured natural | Calculated natural |
|---|---|---|
| frequency | frequency/Hz | frequency value/Hz |
| 1 | 137 | 139.55 |
| 2 | 157 | 143.23 |
| 3 | 304 | 313.97 |
| 4 | 379 | 374.76 |
| 5 | 433 | 427.97 |
| 6 | 448 | 456.55 |
| 7 | 480 | 492.38 |
| 8 | 620 | 618.36 |

| | |
|---|---|
| MAPE | 2.62% |
| RMSE | 8.42 |

Finally, the calculated natural frequency curve and the measured natural frequency distribution point diagram before and after the dynamic parameter identification are visualized as shown in FIG. 6.

The above embodiment confirms the effectiveness of the invention for dynamic parameter identification of dam structures, making it difficult for the existing parameter identification methods to accurately determine the structural dynamic parameters under the condition of considering the random distribution of materials.

The above is only a better embodiment of the invention, and the protection scope of the invention is not limited to this. Any simple changes or equivalent replacements of the technical solution made by any technical personnel familiar with the field should be protected within the technical scope disclosed by the invention.

What is claimed is:

1. A structural dynamic parameter identification method aided by a rPCK surrogate model, comprising:
a finite element model that roughly reflects a structural system to be analyzed is obtained by scaling the structural system to a set proportion;
a probability distribution function of the dynamic parameters in the finite element model is determined by prior knowledge, and a Latin hypercube sampling method is used to generate a dynamic parameter space sample set according to the probability distribution function; wherein the dynamic parameters include a dynamic elastic modulus of a dam, a density of the dam, the Poisson ratio of the dam, a dynamic elastic modulus of a dam foundation, a density of the dam foundation, and the Poisson ratio of the dam foundation;
the dynamic parameter space sample set is analyzed by the probabilistic finite element method, and a response space sample set of the structural system driven by the dynamic parameter space sample set is established;
a robust polynomial Chaos Kriging surrogate model is obtained by mapping the dynamic parameter space sample set to the structural system response space sample set;
the measured response of the structural system to be analyzed is used to drive the robust polynomial Chaos Kriging surrogate model; a Bayesian inference is used to identify the structural dynamic parameters of the structural system to be analyzed, and a Bayesian posterior estimation mean value is used as the structural dynamic parameter estimates of the dynamic elastic modulus and the dam density of the dam and the dam foun dad on.

2. The structural dynamic parameter identification method aided by the rPCK surrogate model according to claim 1, wherein the robust polynomial Chaos Kriging surrogate model M^{PCK} (x) is obtained by using the following formula:
$$Y \approx {M}^{PCK} ( x ) = {\sum }_{α ∈ {N}^{M}} {β}_{α} {ψ}_{α} ( X ) + {σ}^{2} Z ( x )$$
where Y is the structural system response predicted by the surrogate model, M is the number of unknown structural dynamic parameter variables, N^{M} is the set of M dimension natural number vectors, β_{α} is the undetermined polynomial expansion coefficient, α is the subscript of the M dimension basis function index, X={X₁, X₂, . . . , X_{M}} is the M dimension dynamic parameter space sample with independent components, x ∈ Dₓ ⊂ [symbol] ^{M} is the Gaussian process index, σ² is the variance of the Gaussian process, and ZOO is the Gaussian process with zero mean value and covariance functions;
wherein in the formula, ψ_{α}(X) is the joint probability density function orthogonal multivariate basis function relates to X,
$${ψ}_{α} ( X ) = {\prod }_{i = 1}^{M} {ϕ}_{{α}_{i}}^{( i )} ( {x}_{i} )$$
wherein in the formula, αᵢ is the polynomial degree, ϕ_{α}_{ᵢ}⁽ⁱ⁾ is the univariate orthogonal polynomial in the i-th variable according to αᵢ, and xᵢ is the i-th univariate in the dynamic parameter space sample set.

3. The structural dynamic parameter identification method aided by the rPCK surrogate model according to claim 2, wherein the steps to obtain the robust polynomial Chaos Kriging surrogate model M^{PCL} (x) further comprise:
a least angle regression method is used to calculate the undetermined expansion coefficient β_{α} in the robust polynomial Chaos Kriging surrogate model M^{PCL} (x); and
calibrating the Z(x) in the robust polynomial Chaos Kriging surrogate model M^{PCL} (x).

4. The structural dynamic parameter identification method aided by the rPCK surrogate model according to claim 3, wherein the undetermined expansion coefficient β_{α} in the robust polynomial Chaos Kriging surrogate model is calculated by the least angle regression method according to the following formula:
$$\hat{β} = arg {min}_{β ∈ {ℝ}^{P}} E [ {( {β}^{T} ψ ( X ) - Y )}^{2} ] + λ {‖ β ‖}_{1}$$
where β is the polynomial expansion coefficient vector, \hat{β} is the polynomial coefficient that minimizes the mathematical expectation, [symbol] ^{P} is the truncated natural number vector set, where P=A^{M,p} is the truncation error, A ∈ N^{M} is the multi-index truncated set of the polynomial cardinality, p is the polynomial order, λ is the penalty factor of the penalty term, ∥β∥₁ is the norm of the polynomial expansion coefficient vector;
∥\hat{β} ∥₁ is a regularization term that is forced to minimize to support low-rank solutions;
wherein ∥\hat{β} ∥₁=Σ_{α∈A} |β_{α}|

5. The structural dynamic parameter identification method aided by the rPCK surrogate model according to claim 3, wherein the steps for calibrating Z(x) in the robust polynomial Chaos Kriging surrogate model M^{PCK} (x) further comprise:
defining Z(x) as follows:
Z(x)=Cov (Z(xᵢ), Z(xⱼ))=σ²R(xᵢ, xⱼ; θ)
where, Z(xᵢ) is the observed value, Z(xⱼ) is the new interpolation, R(xᵢ, xⱼl θ) is the function describing the similarity between the observed value Z(xᵢ) and the new interpolation Z(xⱼ) by the hyperparameter θ=[θ₁, . . . , θₙ]^{T}, xᵢ and xⱼ are a pair of sampling points in the response space of the structural system;
using the maximum likelihood estimation to estimate hyperparameter θ according to the following formula:
$$\hat{θ} = arg {min}_{θ ∈ {D}_{θ}} \frac{1}{2} [ log ( det R ) + M log ( 2 π {σ}^{2} ) + M ]$$
wherein, in the formula, D_{θ} is the parameter space of θ, R is the abbreviation of R(xᵢ, xⱼ; θ).

6. The structural dynamic parameter identification method aided by the rPCK surrogate model according to claim 1, wherein steps of using Bayesian inference to identify the structural dynamic parameters of the structural system to be analyzed further comprise:
when the unknown structural dynamic parameter variables X={x₁, . . . , x_{M}} cannot be measured directly, it can resort to the engineering measurement or the experimental measurement of structural system response only, establish N independent measurements yᵢ and collect Y [symbol] {y₁, . . . , y_{N}} in the data set r based on those measurements;
a discrepancy term is introduced to link the predicted value X={x₁, . . . , x_{M}} of the model with the observed result Y [symbol] {y₁, . . . , y_{N}} to obtain the calculation model M:
M: x ∈ Dₓ ⊂ [symbol] ^{M} [symbol] y=M (x)+ϵ ∈ [symbol] ^{N}^{ₒᵤₜ}
wherein in this formula, ϵ ∈ [symbol] ^{N}^{ₒᵤₜ} is the discrepancy term describing the difference between experimental observations and model predictions, and ϵ˜N(ϵ|0, σ²); and
the model parameter x_{M} and the discrepancy parameter x_{ϵ} in the structural dynamic parameter vector x are calculated according to the observation result Y [symbol] {y₁, . . . , y_{N}}. The model parameter x_{M} is used to characterize the model prediction value X={x₁, . . . , x_{M}}.

7. The structural dynamic parameter identification method aided by the rPCK surrogate model according to claim 6, wherein the steps for calculating the model. parameter XMand the discrepancy parameter in the structural dynamic parameter vector x are calculated according to the observation result Y [symbol] {y₁, . . . , y_{N}} include:
the joint prior distribution of the model parameter x_{M} and the discrepancy parameter x_{M} is obtained as follows:
π(x)=π(x_{M})π(σ²)
according to the observation result Y [symbol] {y₁, . . . , y_{N}}, the likelihood function of the model parameter x_{M} is obtained as follows;
$$L ( {x}_{M} , {σ}^{2} ; Y ) = {\prod }_{i = 1}^{N} \frac{1}{\sqrt{{( 2 π {σ}^{2} )}^{{N}_{out}}}} exp ( - \frac{1}{2 {σ}^{2}} {( {y}_{i} - M ( {x}_{M} ) )}^{T} ( {y}_{i} - M ( {x}_{M} ) ) )$$
where N is the number of measured response parameters of the structural system to be analyzed, Nₒᵤₜ is the number of response parameters of the structural system to be analyzed predicted by the surrogate model;
according to the joint prior distribution of the model parameter x_{M} and the discrepancy parameter x_{ϵ} and the likelihood function of the model parameter x_{M}, the posterior distribution of the model parameter is obtained as follows:
$$π ( {x}_{M} , {σ}^{2} \vert Y ) = \frac{1}{Z} π ( {x}_{M} ) π ( {σ}^{2} ) L ( {x}_{M} , {σ}^{2} ; Y )$$
wherein in the formula, Z is a normalization factor with a distribution integral of 1;
$$Z {=}^{def} {\int }_{Dx} L ( {x}_{M} , {σ}^{2} ; Y ) π ( x ) dx$$
wherein in the formula, Dx is the parameter space of x; and
the first statistical moment is used to represent the predicted value X={x₁, . . . , x_{M}} of the model according to the posterior distribution based on the model parameter x_{M}, wherein
E[X|Y]=∫_{Dx}xπ(x|Y) dx

8. The structural dynamic parameter identification method aided by the rPCIK surrogate model according to claim 7, wherein the uncertainty of point estimation is quantified by the posterior covariance matrix according to the following formula,
Cov[X|Y]=∫_{Dx} (x=E[X|Y])(x−E[X|Y])^{T}π(x|Y)dx

9. The structural dynamic parameter identification method aided by the rPCK surrogate model according to claim 1, further comprises:
a sample spectrum of the structural system to be analyzed is constructed by using the dynamic parameter space sample set and the structural system response space sample set;
the prediction model is generated based on the sample spectrum of the structural system until the accuracy of the prediction model meets the requirements; the prediction model is used as a robust polynomial Chaos Kriging surrogate model; otherwise, the dynamic parameter space sample set and the system response space sample set are repeatedly generated, and the prediction model is established by using the new dynamic parameter space sample set and the system response space sample set until the accuracy of the prediction model meets the requirements.

10. The structural dynamic parameter identification method aided by the rPCK surrogate model according to claim 1, further comprises:
the high-fidelity finite element model of a structural system is established by using structural dynamic parameter estimates; and
the system response of the high-fidelity model is compared with the measured structural system response.
